(19) United States
(12) Patent Application Publication
(10) Pub. No.: US 2009/0165041 A1
(43) Pub. Date: Jun. 25, 2009

(54) System and Method for Providing Interactive Content with Video Content

(76) Inventors: John S. Penberthy, Croton on Hudson, NY (US); Simon A. Assaad, Far Hills, NJ (US); David V. Carson, Westport, CT (US); Bradley G. Johnson, Brooklyn, NY (US)

Correspondence Address: CAPITAL LEGAL GROUP, LLC, 1100 River Bay Road, Annapolis, MD, 21409, US

(21) Appl. No.: 11/963,352

(22) Filed: Dec. 21, 2007

(51) Int. Cl. H04N 7/08

(52) U.S. Cl. 725/34

(57) ABSTRACT

A system and method of providing contextual content to an end user viewing a video in a video player in a client is provided. In one embodiment the system and method of provides contextual content via an interactive video skin to an end user viewing a video in a client. These video skin may surround the viewing portal and (1) provide contextual information in the areas outside the video viewing area, (2) embody logic that manipulates the video stream to insert audio, text, graphics, and/or video, (3) interact with third party servers, (4) interact with the user via menus, buttons, and/or graphical widgets, or (5) any combination thereof. In one embodiment, the method may comprise determining contextual data for the end user that comprises one or more of: geographical information of the end user; demographical information of the end user; personal information of the end user, video metadata, and technical data related to the end user's computer or the network to which the computer is connected. Next, the method may include determining advertising content to present to the end user based on the contextual data and presenting the advertising content to the end user concurrently with the video player such as along a periphery of the video player. The advertising content may include a user input mechanism configured to receive information from the end user in which case the method may further include receiving information from the end user via the input mechanism, determining secondary content to present to the user based on the received information, and presenting the secondary content to the end user. The method may also include receiving one or more content elements selected based on the contextual data and supplying the one or more content elements to the video player for integration into the video to thereby customize the video.

### FIELD OF THE INVENTION

The present invention generally relates to a system and method for providing an interactive content and more particularly, to a system and method for providing interactive content to provide contextual advertisements for presentation with video content and for customizing the video content in a packet based communication system such as the Internet.

### BACKGROUND OF THE INVENTION

In broadcast networks, such as broadcast television and radio, the same advertisement is typically inserted into the media stream for presentation to all the end users. In such networks, there typically is no means for determining with precision how many end users experienced (e.g., viewed) an advertisement, which end users experienced the advertisement, or which end users responded to the advertisement. In addition, advertisements communicated via a broadcast network are not interactive, and, therefore, do not allow the operator to provide contextual advertising based on information about the viewer (e.g., the view's location, demographics, etc.), allow the viewer to supply personal information or request additional information, or facilitate impulse responses to the advertisements.

In contrast, interactive networks such as the internet are more amenable to the selective and precise distribution of advertising. Internet advertising in which advertisements are sold based on the number of impressions or the number of click-throughs is well known. Typically, such internet advertisements comprise a still image (e.g., a banner ad) or a hyperlink that is presented as part of a static web page.

While the Internet has become a widespread means of communicating data, it is on the verge of becoming a primary means of communicating video content around the world. Most web pages include text, graphics, and other non-video data. However, as broadband becomes ubiquitous, more and more end users are receiving and transmitting video over the Internet. Video files and some audio files tend to be larger than other types of files. The availability of broadband allows users to transmit and receive larger files in acceptable time frames. Thus, the adoption of broadband, at least in part, has led to the increase in the amount of video and audio data communicated over the Internet.

It would be desirable to provide advertisements supplied with video that are pertinent to contextual information of the end user such as the user's location, demographics, personal information, information about the end user's computing device, information about the network to which the end user's computer is connected, and/or other information. In addition, it would be desirable to provide advertisements associated with video that are pertinent to the video such as information about the subject matter of the video, rating of the video, and/or other information. Further, it would be desirable to customize the video based on the contextual information.

Obtaining the contextual information, however, can be challenging. For example, end users typically do not wish to be bothered with providing information each time he or she views a video. Providing contextual advertisements—especially wherein the advertisement is personalized to the end user (e.g., includes the end user's name)—and customizing the video content based on the contextual information provides additional challenges. Consequently, there is a need for a system and method for providing interactive content to provide contextual advertisements for presentation with video content and for customizing the video content in a packet based communication system such as the Internet.

These and other advantages are provided by various embodiments of the present invention.

### SUMMARY OF THE INVENTION

The present invention provides a system and method of providing contextual content to an end user viewing a video in a video player in a client. In one embodiment, the method may comprise determining contextual data for the end user that comprises one or more of: geographical information of the end user; demographical information of the end user; personal information of the end user, video metadata, and technical data related to the end user's computer or the network to which the computer is connected. Next, the method may include determining advertising content to present to the end user based on the contextual data and presenting the advertising content to the end user concurrently with the video player such as along a periphery of the video player. The advertising content may include a user input mechanism configured to receive information from the end user in which case the method may further include receiving information from the end user via the input mechanism, determining secondary content to present to the user based on the received information, and presenting the secondary content to the end user. The method may also include receiving one or more content elements selected based on the contextual data and supplying the one or more content elements to the video player for integration into the video to thereby customize the video.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a functional block diagram of one example architecture that may be used to implement some example embodiments of the present invention.

FIG. 2 is a schematic representation of an example video skin ad in accordance with some example embodiments of the present invention.

FIG. 3 is a schematic representation of another example video skin in accordance with some example embodiments of the present invention.

FIG. 4 illustrates an example video skin ad and video player in accordance with an example embodiment of the present invention.

FIG. 5 illustrates an example of another video skin ad and video player in accordance with an example embodiment of the present invention.

FIG. 6 is a schematic representation of an example interstitial advertisement in accordance with some example embodiments of the present invention.

FIG. 7 illustrates an example interstitial ad and video player in accordance with an example embodiment of the present invention.

FIG. 8 provides a functional block diagram of a system for implementing some example embodiments of the present invention.

FIG. 9 provides a flow chart for implementing some example embodiments of the present invention.

### DETAILED DESCRIPTION OF ILLUSTRATIVE EMBODIMENTS

In the following description, for purposes of explanation and not limitation, specific details are set forth, such as particular networks, communication systems, computers, terminals, devices, components, techniques, advertisements, ad units, ad unit types, servers, communication paths, data and network protocols, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, terminals, devices, components, techniques, advertisements, ad units, ad unit types, servers, communication paths, data and network protocols, software products and systems, operating systems, development interfaces, and hardware are omitted so as not to obscure the description.

System Architecture and General Design Concepts

The present invention provides a system and method for providing interactive content for providing contextual advertisements with video content and for customizing the video content in a packet based communication system such as the Internet. The contextual advertisements may include advertisements (sometimes also referred to herein as “advertising” or “ads”) that are displayed before the video, concurrently with the video, between segments of the video content, and/or after completion of the video. Specific examples of such advertisements are provided below. The interactive content may include control logic to control the display and/or selection of the contextual advertisements and to interact with the end user and/or the video player.

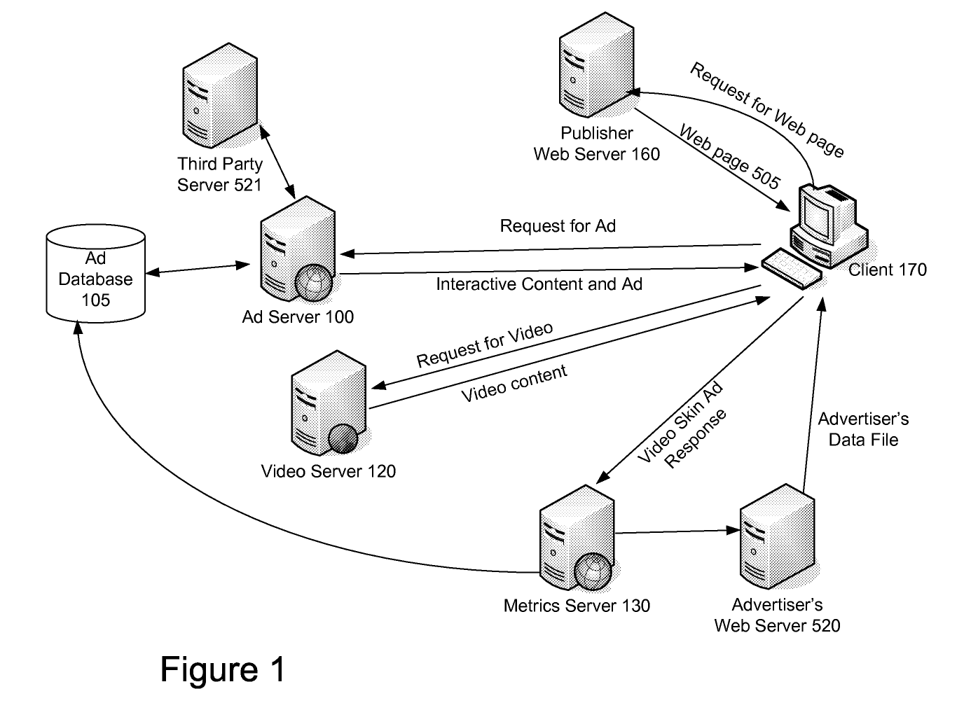

FIG. 1 illustrates the functional components of one example environment that may be used to provide interactive content according to one example embodiment of the present invention. This example environment includes an ad server 100, ad database 105, video server 120, metrics server 130, advertiser's server 140, publisher web server, third party servers 521, and the client 170 (e.g., a web browser executing on the end user's computing device). As will be evident to those skilled in the art, in practice there would likely be a plurality of publisher web servers 160, clients 170, and other servers. However for ease of explanation only one of each is illustrated. In addition, this architecture is one example of an architecture for implementing some embodiments of the present invention and the present invention may be implemented using numerous other architectures.

The servers described herein may include one or more computer systems that each include a processor, memory, user input and user output mechanisms, a network interface, and executable program code (software) stored in memory that executes to control the operation of the server. Various commercially available computer systems and operating systems software may be used to implement the hardware and software. The components of each server may be co-located or distributed. In addition, all or portions of the same software and/or hardware may be used to implement two or more of the functional servers shown. Thus, in some embodiments the components of FIG. 1 may be considered functional components that employ the same hardware and some of the same program code. Other embodiments may include different functional components. In addition, the present invention is not limited to a particular environment or server configuration.

The publisher web server 160 may comprise any web server hosting a website (comprised of one or more web pages) that includes a link for requesting video content stored on the video server 120. When end users click on a link in one of the web pages (or when such web page is loaded), the client 170 sends a request for the associated video to the video server 120 and a request for one or more advertisements (and/or customized video content for insertion into the video) to the ad server 100.

In this example embodiment, the ad server 100 may store, select, customize, and transmit advertisements as well as digital data (e.g., forms, images, video, audio, etc.) to the client 170 to be inserted into advertisements and/or video. Specifically, the ad server 100 may receive a request for advertisements and, in response, select one or more advertisements based on contextual data and transmit the selected advertisements (including interactive content). The requests may originate from a publisher's web server 160 (in response to a client 170 requesting a web page) or from a client 170 upon initiation of a video (e.g., a user clicking on a link to view a video or loading of a web page). The ad server 100 may request and receive information from the ad database 105 that may include contextual data, impression data, configurations setting, campaign criteria data, and/or other data for selecting an advertisement. The ad server 100 also may store data in the ad database 105. In addition, the ad server 100 may request and receive digital information (e.g., images, video, audio, etc.) from third party servers 521 to be inserted into a video to thereby customize the video or retrieve such digital information from memory. In one example, the ad server 100 receives the contextual information from clients 170 and provides one or more contextual advertisement by selecting and/or customizing advertisements based on the contextual information.

The ad server 100 may then transmit the contextual advertisement(s) and/or content elements to the client 170. The ad server 100 may also transmit the control logic of the interactive content to the client 170. In other embodiments, the control logic is received at the client as part of the web page 505 from the publisher web server 160. The advertisement may include a form or other input mechanism for receiving information from the end user, which may be used by the ad server 100 or an application in the client 170 to provide additional contextual data to the ad server. When the user clicks on an ad, a request is transmitted from the client browser 170 to the advertiser's server 520, directly or indirectly. As illustrated, actuation (e.g., clicking) of the ad may cause the ad response to be transmitted first to a third party server 510 (e.g., a third party such as DoubleClick®) that provides tracking and other internet metrics for the advertiser and then the request is re-directed to the advertiser's server 520 (or any desired server), which may respond by transmitting the desired data file as shown.

An application on the end user's computing device (e.g., executing in the client), may generate and transmit impression data that includes information of the advertisement(s) that are displayed by the client 170. In addition, other data transmitted may include the date, time, information identifying the webpage in which the video is embedded, information of the domain (e.g., the web site), information of the IP address (of the end user's computing device), user information (e.g., the location, address, sex, age, interests, hobbies, web pages previously viewed, domains visited, etc.) and other information such as information sufficient to determine whether a link (or form) associated with the advertisement was actuated. The impression data is received by the metrics server 130, which processes and writes the impression data to the ad database 105.

The video server 120 stores a plurality of videos and, in response to receiving a request, transmits the requested video content to the requesting client 170. The metrics server 130 receives responses to advertisements, stores various metrics in the ad database, and forwards data of the responses to the appropriate advertiser's web server 520, which transmits a data file to the responding client. The video player that presents the video may be transmitted from the publisher web server 160 as part of the web page 505, from the ad server 100, or from the video server 120.

Thus, the present invention also provides for the syndication of interactive content for providing contextual advertisements and customized video meaning that the contextual advertisements and/or customized video can be published through numerous publisher web servers 160 (and websites) concurrently.

### Example Embodiments

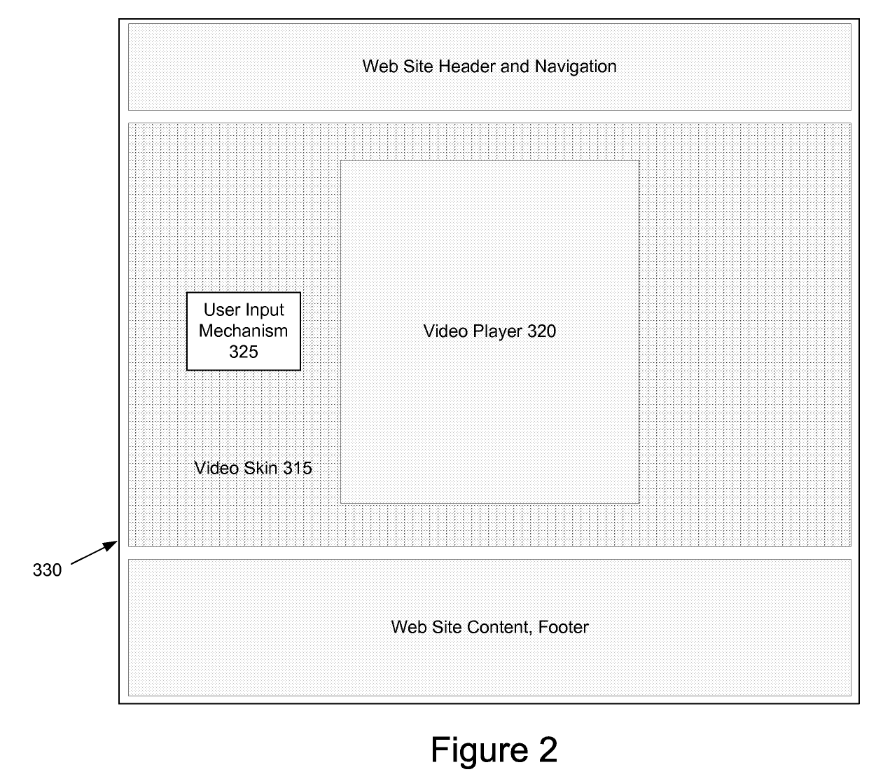

As discussed, the present invention provides a system and method for providing contextual advertisements for presentation with video content and for customizing the video content (sometimes also referred to herein as “video”). The contextual advertisements may be presented in an interactive video “skin” (illustrated in FIG. 2) and comprise advertisements that are selected and/or customized based on contextual information such as one or more of geographical information of the end user, demographical information of the end user, personal information about the user, technical information of the end user's computing device (and/or network), information of the video, and/or other data. As will be discussed in more detail, the advertisement may be selected or customized in any suitable manner such as by, for example purposes only, (1) providing information of venders local to the end user, (2) selecting advertisements that are targeted to the end user's demographics, (3) personalizing the advertisement (e.g., inserting the end user's name or photograph in the advertisement), (4) selecting scenery based on the end user's location or time, (5) sizing and formatting the advertisement according to the user's computing device, and (6) various other customizations. The video may also be customized by inserting a product (i.e., product placement) targeted at the user, the user's demographics, and/or end user's location; personalizing a portion of the video (e.g., inserting a photo of the end user), personalizing text in the video (inserting the user's name on a marquee), and/or inserting audio content of the user in the video, or any other such customization. These selections and customizations are for example purposes only and the present invention is not limited to these examples.

Various types of contextual advertising may be presented to the end user. As discussed, advertising associated with video content may include advertisements that are displayed before the video content, concurrently with the video content (i.e., both the video (or video player) and the ad being present during overlapping time periods), between segments of the video content, and after the video content.

The video content is presented to the user by a video player, which comprises a software program that executes on the user's computing device. The video player of this example embodiment may allow the end user to hear audio content, hear and see video content, select and create channels, search for videos and/or channels, subscribe to a channel, and take other actions. In this example embodiment, the video player comprises a Flash application that executes within the existing browser window (client 170) along with the advertisements. In another example embodiment, a new browser (a pop-up) window is initiated and the video player is actuated and the player is disposed in the new browser with the advertisement, such as a video skin. The present invention, however, is not limited to a particular type of advertisement or video player.

Each type of advertisement may be configured to display at a different time or location (relative to the video content) from other advertising types. The various advertising types may be of the same or different file type (e.g., jpeg, swf, flv, mpg, etc.). FIGS. 2-5 illustrate a first type of advertisement referred to herein as a video skin ad 315 that is configured to be displayed along a periphery of the video player 320 and, in some instances, concurrently with video content (the video content that is presented by the video player 320). The video skin advertisement 315 may comprise a gif, jpeg or other still image type or a flash or other rich media type, and may include an associated hyperlink (i.e., a click-through URL) and/or form for receiving information from the user and is discussed in more detail below. In this example, the video skin ad 315 extends around the entire perimeter of the video player 320. In other embodiments, the video skin 315 does not extend around the entire perimeter of the video player 320, but instead is adjacent each vertical side of the video player, 320, each horizontal side of the video player, or only one side of the video player 320.

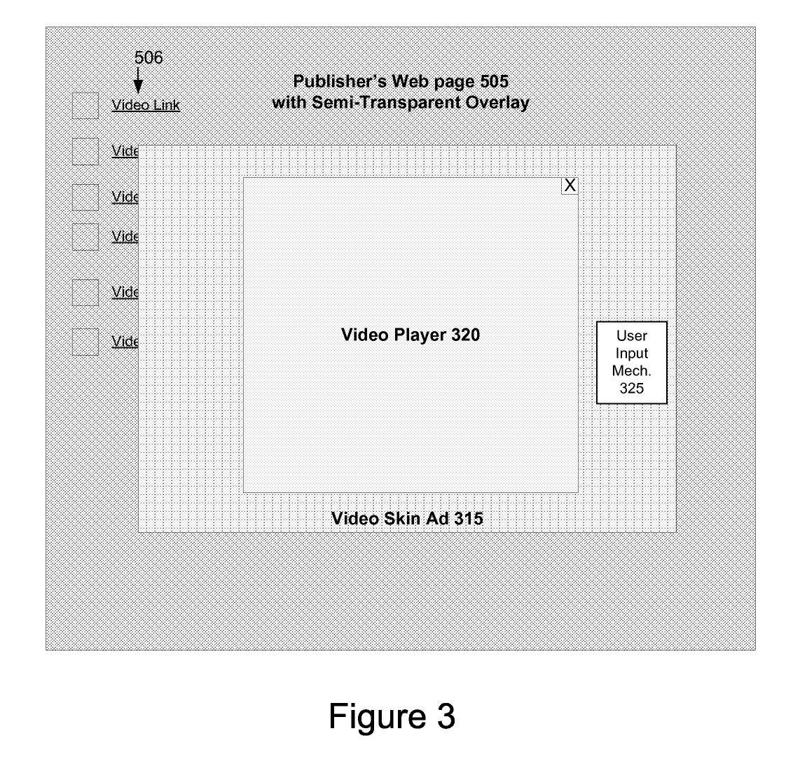

FIGS. 2 and 3 illustrate example embodiments of a video skin 315 that is presented with a video player 320. In one embodiment illustrated in FIG. 2, the video player 320 and video skin ad 315 may be presented in a new browser window 330 or new tab within the browser. Depending on the embodiment, the web page 505 that contains the hyperlink to the video, the video player 320, or an application in the browser window 330 presenting the advertisement (e.g., the control logic of the interactive content) may transmit a request for the video skin ad 315, transmit notification of the impression, and/or transmit notification of a click-through of the ad unit.

In another embodiment (and as illustrated in FIG. 3) the video skin ad 315 and video player 320 may be displayed over (in front of and partially obscuring) the publisher's web page 505. In other words, the video skin 315 and player 320 need not be presented in a separate browser window, but may displayed over the existing web page 505 (i.e., the web page 505 that includes the hyperlink 506 to the video content). In one example embodiment, the video player 320 and the video skin ad 315 may be presented as part of a flash application that initiates when the user clicks on the hyperlink 506 associated with the video. The flash application controls the display of the video player 320 over the video skin ad 315.

In yet another embodiment, the video skin ad 315 may comprise a piece of embedded “content” that is entirely independent of the video player and displayed above the player, in a separate layer. More specifically, the video player 320 and the video skin ad 315 may be displayed the topmost Cascading Style Sheet (CSS) layer of the publisher's web page 505. Depending on the embodiment, the video player 320 may be the publisher's proprietary player, a player service such as Brightcove®, or a third party embedded player 320, such as from YouTube®. In other embodiments, the displayed elements could also include a combination of “content” served from the publisher's web server and any of the above types of player. For example, the video skin ad 315 may appear in a CSS layer below a video player 320 in a window-like border (with a close box in the upper right corner) as illustrated in FIG. 3. In this example, the video player 320 could be received from any server, the border may be served by the publisher's web server, the video skin ad 315 may be embedded content from the ad server 100, and the web page 505 below the other elements may be served by the publisher's web server. The CSS layering of those elements is controlled by the logic (i.e., JavaScript code within the web page) served by the publisher's web server 160. Various other means of presenting the video skin ad 315 to the end user may also be used.

Referring to FIGS. 2 and 3, the video skin 315 may include a user input mechanism 325 that allows the user to input information or otherwise interact with the advertisement (and its associated control logic). The user input mechanism is shown schematically in FIGS. 2 and 3 and may comprise any suitable mechanism for obtaining the desired information including, but not limited to, one or more of text fields, text areas, check boxes, radio buttons, and/or drop down lists.

The video skin ad 315 may include an associated hyperlink that provides a click through to an advertiser URL so that if the user clicks a portion of the video skin ad 315, additional content (e.g., a form, a more detailed advertisement or other content) is presented. Specifically, in one example embodiment if the user clicks on the video skin ad 315, the client browser transmits a request to the advertiser's server (or, alternately, a third party server) for a data file, which (depending the advertiser, the link, and other factors) may be an HTML page (i.e., a web page), a video, a flash animation, an audio file, and/or other content. The content of the data file may include (1) an offer to provide more information, for example, including a form to allow the user to provide his or her personal information such as name, address, email address, phone number, etc.; (2) additional information about the advertiser's product or service; (3) a request that the user purchase of a product or service (e.g., additional information with a “buy now” link); (4) a request for payment (e.g., a form to allow the user to provide credit card information); (5) an offer to download content; or (6) some combination of these. The data file may be presented in the video skin or in a new browser window. In addition thereto or alternately, the video skin ad 315 may display a user input mechanism for supplying additional information to, for example, purchase a product or service, request additional information (e.g., related to the video), or otherwise interact with the video skin (and/or advertiser).

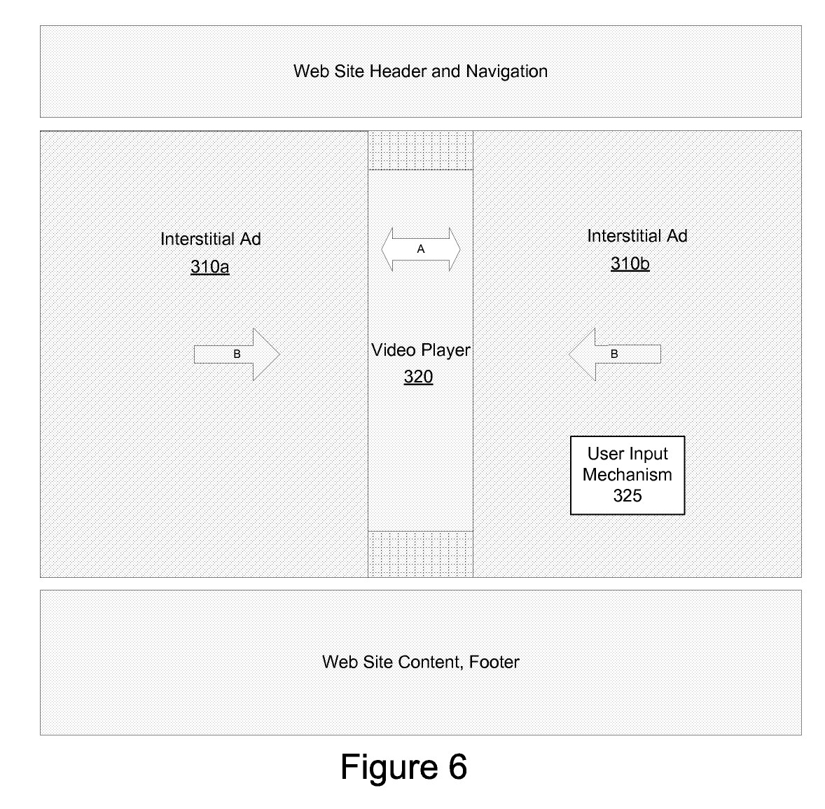

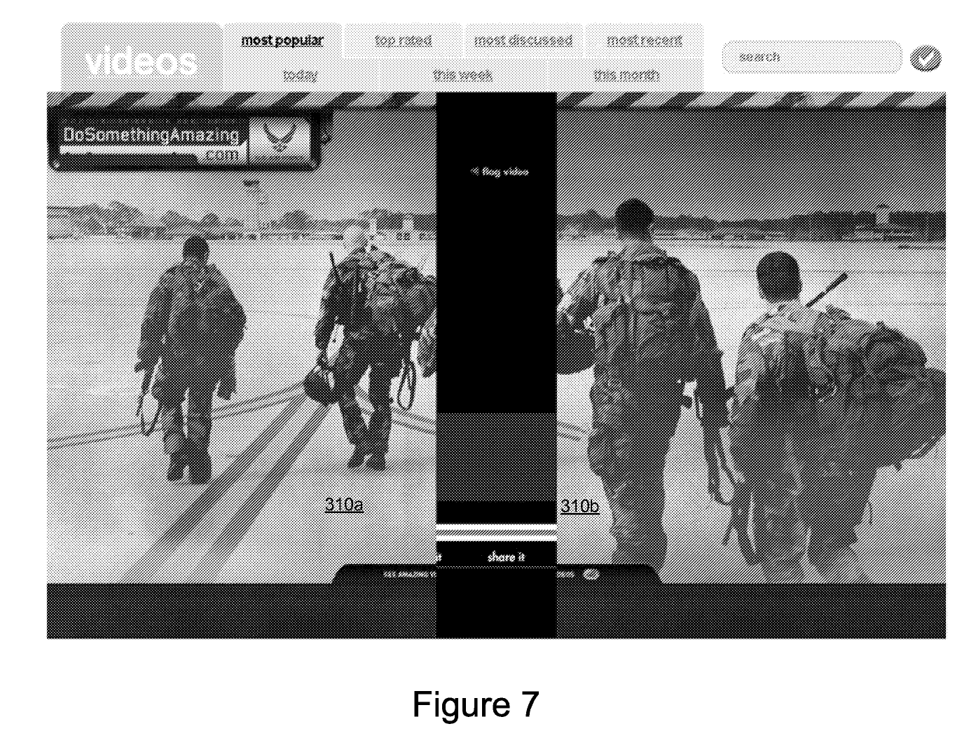

A second type of advertisement is an interstitial advertisement that may comprise one or more images (static or video) that are displayed prior to (or after) the video content and that split apart into multiple portions just prior to the beginning of the video content (or come together just after the end of the video content), and may act as a pre-loader while the upcoming video is buffered or transmitted. Referring to FIGS. 6 and 7, one example interstitial advertisement, a jpeg image (although other embodiments may include one or more jpeg, gif, mpg or other files) separates along a vertical line in a manner that is similar to two doors sliding apart to reveal the beginning of the video content. The interstitial advertisement also may include audio content. The arrows in FIG. 6 illustrate the movement of the interstitial ad of one example embodiment. Specifically, the Interstitial ad may comprise a sliding-door style ad that opens (as indicated by arrow A) such as, for example, at the beginning of the video (or prior to presentation) and to reveal the video player and video. When the interstitial ad finishes opening, it may no longer visible in some embodiments (e.g., and, in some embodiments, may open to reveal a video skin ad 315). In addition, when presentation of the video is complete, the doors 310a,b of the interstitial ad 310 may come together to close completely (as indicated by arrows B). The Interstitial ad 310, while wholly visible or partially visible, (either at the beginning or after the video presentation) may provide a click through to an advertiser URL so that if the user clicks on any portion of the interstitial ad the advertiser's content is presented and/or a user input mechanism 325 (e.g., form inputs) to allow the user to supply information. FIG. 7 provides an example of such an interstitial ad 310 that has begun to separate into two portions 310a and 310b. When the user clicks on the interstitial ad or submits a form in the interstitial ad, the client browser transmits a request to the ad server 100 (or, alternately, the advertiser's server or a third party server) for a data file, which (depending the advertiser, the link, and other factors) may be an HTML page (i.e., a web page), a video, a flash animation, or other content.

A Pre-roll advertising type comprises an advertisement (e.g., video or still image) that is presented to the viewer just prior to the beginning of the video content and may include an associated hyperlink to the advertiser and/or a form. The interstitial ad 310 may form one type of pre-roll advertisement. While not included in this example embodiment, other implementations may further include a post-roll advertising type, which may comprise a video (or still image) that is presented to the viewer at the end of the video content (which an interstitial ad that closes may comprise one example). In addition, other implementations may further include one or more mid-roll advertisements that comprise a video (or image) that is presented to the viewer at one or more cue points (location and/or time) in the middle of the video content (between segments of the video). The various ads types may be controlled by the same or different control logic.

The following example is described in the context of a video skin ad 315. However, the invention is equally applicable for use in other ad types including a pre-roll ad, a post roll ad, or a mid-roll ad (any of which may comprise an interstitial ad or other ad type).

Depending on the embodiment, the present invention provides a method providing interactive content to provide contextual advertisements with video content and/or customize the video content. As discussed, the interactive content may comprise a programmable object (e.g., an application) that contains control logic (e.g., program code that executes rules according to business logic) that executes on the end user's computing device (e.g., in a client browser 170). The logic may have access to one or more of the (1) geographic location information of the end user, (2) demographic information of the user, (3) information about the video (e.g., cue points for inserting data, subject matter type of the video, rating of the video), and (4) technical information (e.g., about the end user's computer or the network to which the computer is connected). In other embodiments the logic may have access to different and/or additional information. The contextual information may determined, retrieved, or received via a backend database (e.g., the ad database), HTTP (HyperText Transfer Protocol) values (e.g., IP address, variable, parameters, status codes, data in headers, etc.), and/or Internet media-type tags (sometimes referred to as Multipurpose Internet Mail Extensions (MIME) tags—content type, type of device, from browser). An Internet media type, also sometimes referred to a Content-type, is a two-part identifier for file formats on the Internet. An internet media type is composed of two or more parts: a type, a subtype, and one or more optional parameters.

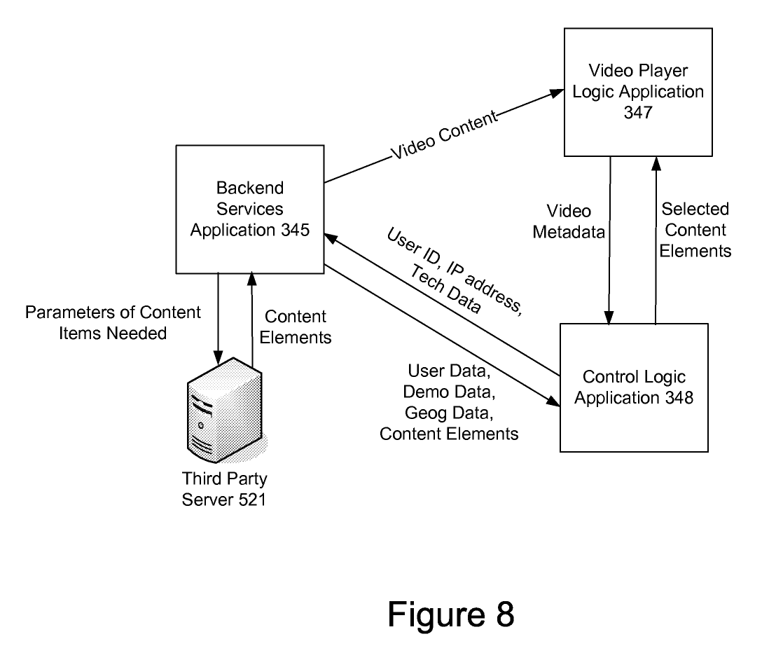

In one embodiment, the present invention may be implemented via three applications that perform separate logical functions as illustrated in FIG. 8. First, a backend services application 345, which may reside on the ad server 100 (or other remote computer), communicates with third party servers and transmits data to the control logic application 348. For example, the backend services application may provide parameters of the advertisement content needed to third party servers, receive advertisements meeting those parameters, and transmit some of the received advertisements to the control logic application 348. Second, a video player logic application 347, which may execute in the browser 170, communicates data between the backend services application 345 and a control logic application 348. The video player logic application 347 may form part of, or communicate with, the video player 320 (that plays the video) and may communicate video metadata (e.g., video cue points, acceptable content elements, subject matter type of the video, etc.) to the control logic application 348. More specifically, the video player logic application 347 may provide “cue points” to the control logic application 348 including (1) the spatial location, duration, and/or size of a text, graphic, image or video insertion, (2) the type of information acceptable for insertion (e.g., as identified by well known values, subject to future standardization). For example, a video may permit insertion of an image of a standard size (e.g., 90×128), to promote a product. The video player logic application 347 also may request information such as a “client name,” “client location,” “phone number,” and other such information (e.g., to be integrated into the video). Such information and requests may be provided to the control logic application 348.

Finally, the control logic application 348, which may comprise a JavaScript application that executes in the browser 170, communicates with the backend services application 345 and the video player logic application 347. For example, the control logic application 348 may use the above mentioned cue points to retrieve information from a third party server (e.g., via the backend services application 345 or directly) or the ad server 100, and then insert the digital information into the video by communicating with the video player logic application 347. The schematic of FIG. 8 illustrates one embodiment and examples of some of the types of data that may be communicated. However, in some embodiments at least some of such data need not be communicated to and from the backend services application 345 and, instead, the control logic application 348 includes logic, data, and content elements (received upon loading or stored on the end user's computing device) sufficient for customizing the advertisement and/or video.

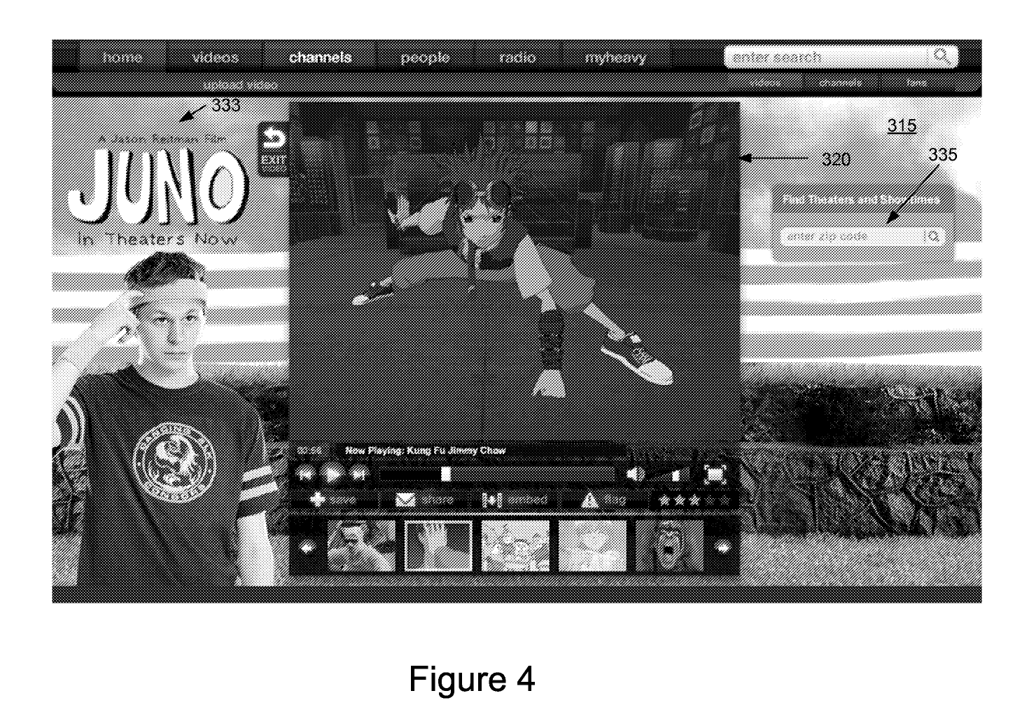

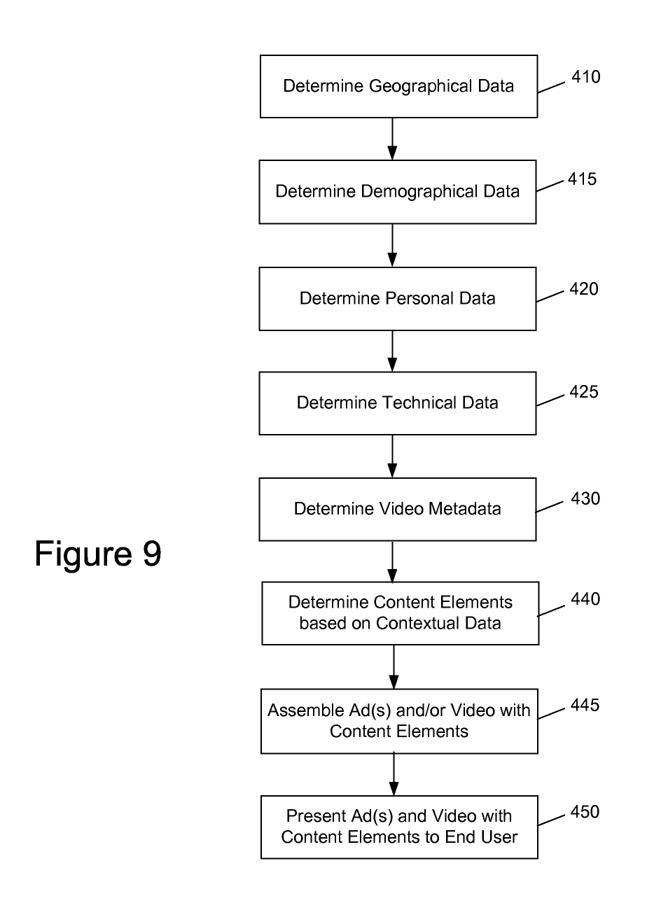

FIG. 9 provides a flow chart of the processes that may be performed in an example system and method. At step 410, geographical data may be determined, for example, based on the IP address of the end user's computing device. More specifically, the control logic application (CLA) 348 may obtain the IP address (or a User ID from a cookie) of the end user's computing device and transmit the IP address (or User ID) to the backend services application (BSA) 345 or other remote computer. In response, the BSA 345 (or the other remote computer) may transmit a zip code (or address) or other geographical data back to the CLA 348. Alternately, the CLA 348 may present a form 335 in the video skin 315 that requests the user's zip code (as illustrated in FIG. 4) or other information. The user may then supply the zip code (or other geographical information) via the video skin ad 315. Alternately, location information (e.g., a zipcode) may be stored in a cookie on the end user's computing device that is retrieved by the CLA 348.

At steps 415 and 420 demographical data and personal data, respectively, may be determined by the CLA 348 via a form into which the user supplies information. Alternately, or in addition thereto, the CLA 348 may retrieve information identifying the end user (e.g., a user ID) from a cookie stored on the end user's computer and transmit the user ID to the BSA 345. Using the user ID, the BSA 345 may then access the database to retrieve demographic and/or personal information that has been previously supplied by the end user or otherwise determined. Alternately, some demographical data (e.g., user's gender) and personal data (e.g., user's first name) may be stored in a cookie on the end user's computing device that is retrieved and used by the CLA 348.

The CLA 348 may determine technical data at step 425, which may include information about the end user's computer or the network to which the end user's computer is connected via the client browser 170. For example, the CLA 348 may determine the type of computing device, the browser (and version), the operating system, and other data. Such data is readily available via program code in the browser 170 as is known to those skilled in the art.

At step 430, the CLA 348 may receive data about the video (video metadata) from the video player logic application 347. The video metadata may include one or more of the video's rating, the subject matter type of the video (e.g., cars, extreme sports, sports, comedic, etc.), accepted content types for customization of the video (e.g., audio, video, still images (such as jpeg), etc.), cue points of the video, sizes of content elements, and other parameters and data related to the video.

It is worth noting that in some instances, some of steps 410-430 may be omitted. For example, if the video is being played in a video player that does not provide video metadata, step 430 may be omitted. If the user's computing device is configured to prevent the storage of cookies, step 415 and/or 420 may be omitted. In addition, the sequence of processes 410-430 may be arbitrary and, depending on the embodiment, may be performed in any order or concurrently. In addition, in other embodiments the system may use other data for providing contextual advertisements and/or customizing the video.

At step 440, the system determines the one or more content elements to be used to customize the advertisement and/or video. This process 440 may include selecting—based on the data collected from any of steps 410-430—one or more existing content elements from a plurality of content elements stored in memory. A content element may comprise an advertisement, a still image that may form a portion of an advertisement or video (i.e., be inserted into the video), an audio file that may form part of an advertisement or the video, or a video clip that may form part of an advertisement or the video. This process 440 also may include constructing content elements such as by creating a customized still image (such as cropping and formatting a photo of, or from, the user or constructing an image with the user's name), processing a video supplied by the user, or processing an audio file supplied by the user. In addition, the process 440 may include requesting and receiving content elements from third party servers. Depending on the embodiment, this process 440 may be performed by the CLA 348 (i.e., on the end user's computing device), by the BSA 345 (remote from the end user's computing device) or some combination of both.

At step 445, the CLA 348 (and/or BSA 345) assembles the advertising (if necessary) to provide contextual advertising and/or customizes the video with the content elements (determined in step 440). For example, some content elements may be selected (or constructed or received) by the BSA 345 (at step 440) and transmitted to the CLA 348, which inserts some of the received content elements into an advertisement in the video skin ad 315. In addition, some of the determined content elements may be provided to the video player logic application 347, which inserts the content elements into the video according to the corresponding cue points to thereby customize the video. In some embodiments, this process 445 (assembling) may be a logical function performed when the advertisement and/or video is presented at step 450.

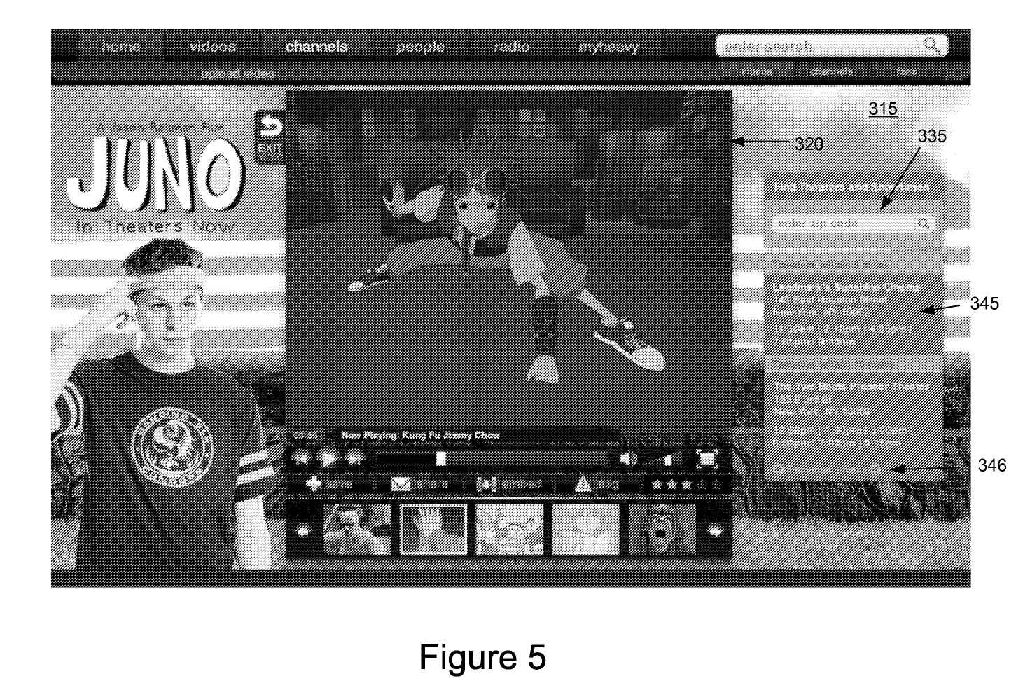

At step 450, the contextual advertisement and/or the customized video is presented to the end user. An example is shown in FIG. 5 in which, in response to receiving the a zip code supplied by the end user, the BSA 345 transmits data of the theaters within five miles of the supplied zip code and the CLA 348 presents the received data in the video skin ad 315. Example implementations of these steps are provided below.

In summary, by determining contextual information (e.g., geographic, demographic, personal, technical information of the user, and video metadata) the system can provide contextual advertisements and/or video that is customized based on the contextual data. Such customization may include, but is not limited to: (1) utilizing the geographic and/or demographic information to select appropriate images and/or advertisements to be presented by the video skin 315 (or video player in the video); (2) using geographic information to customize (e.g., personalize) the images, language, and form of the ad; (3) choosing a form, text, image, or video based on the machine, operating system, browser, television, or network used by the user viewing the video; (4) selecting and/or modifying advertising content elements and/or content elements to be inserted into a video based on contextual data, or (4) some combination thereof.

The CLA 348 may use one or a combination of methods to customize content for the end user. For example, the video skin 315 may personalize the images, language, and/or other content and/or select images, videos and/or other content by (1) sending a request for appropriate advertising content (e.g., a request for an image, form, video, and/or language text); (2) sending a request for a particular type of image, form, and/or video; (3) selecting one or more of a plurality of images, forms, videos, language texts that are sent with (or to) the CLA 348 (as part of the video skin and/or video player); (4) via another suitable method; or (5) some combination thereof.

FIGS. 4 and 5 illustrate an example implementation of the present invention for providing contextual advertising in a video skin. Referring to FIG. 4, an end user has clicked on a link to view a video (an animation) that is depicted in the video player 320. The video skin ad 315 is shown presenting a contextual advertisement that comprises an advertisement for a movie, Juno®. In this example embodiment, the advertisement 315 has been selected based on the content of the video (an animation) because it is likely that an end user who is interested in the animated video may be a target market for the movie Juno. The video skin ad 315 also includes a form 335 that allows the end user to supply a zip code in order to find nearby theaters that are showing the movie Juno. When the user enters a zip code and submits the form 335, the CLA 348 transmits the zip code to the BSA 345 (or other remote server), which responds with information of the theaters near the zip code that are showing Juno. Upon receipt of the theater information, the CLA 348 causes the video skin ad 315 to display the theaters 345 as is illustrated in FIG. 5. As is evident from the bottom of the theater information, the video skin ad 315 also displays navigation buttons 346 to allow the user to page through additional lists of nearby theaters showing the movie. In addition, in an alternate embodiment, the CLA 348 may cause the video skin 315 to display a form for purchasing tickets to the movie at a theater selected by the end user. Thus, the video skin ad 315 interacts with the end user. In other implementations, an advertisement for a particular type of automobile (e.g., Nissan®) may be presented as the video skin ad 315 (e.g., because the video relates to automobiles) with a form 335 used to supply a zip code that is subsequently used to determine and provide the nearby dealerships offering the particular type of automobile. In other embodiments, the form 335 may be used to collect information from the user such as the user's email address, phone number, name, home address, profession, and other personal or demographic information.

As discussed, the CLA 348 may be configured to customize the video by providing digital information from third party servers to the video player logic application (VPLA) 347 for insertion into the video at specified cue points, which may result in modification of the video being presented to the end user. In this way, the CLA 348 may facilitate customization of the video. The cue points of a video comprise time points within a video and may be tagged with type of content element that is expected (e.g., image, audio, video, text, etc.). Thus, the video customization feature may be used to provide product placement within the video content (e.g., a car, can of soda), placement of user generated content in the video (e.g., photos, videos and/or voices), placement of background scenery based on the time of day and/or geographical location (e.g., an early morning sunrise in Manhattan, N.Y. or a night time skin in Los Angeles, Calif.), placement of custom messages in the video (such as placing the user's name on the marquee of a cinema within the video), and other such customizations.

The CLA 348 may use any suitable method of providing the digital information from the third party server to the video player. In one example, the CLA 348 uses a communication channel between the video player 320 and the web browser 170. With a Flash video player, for example, the CLA 348 may use an ExternalInterface call that binds JavaScript to functions in Flash.

As an example, the CLA 348 may provide a request to the video player logic application 347. The request may include a request for one or more of the video's rating, the subject matter type of the video (e.g., cars, extreme sports, sports, comedic, etc.), accepted content types for customization of the video (e.g., audio, video, still images (such as jpeg), etc.), cue points of the video, and other parameters and data related to the video (collectively referred to herein as video metadata). In response, the video player logic application 347 may supply all (or some) such information to the browser logic application 348. In addition and as discussed above, the CLA 348 also may determine (or receive via the browser 170) information identifying the type of computing device (e.g., mobile telephone versus notebook computer), the browser type, user and/or demographic information (e.g., received from a backend database based on a user ID from a cookie stored on the user's computing device), geographic information (e.g., based on information in a cookie, the IP address of the computing device, or zip code supplied by the end user), and other information (e.g., such as information supplied by the user via a form in the video skin ad 315).

Upon obtaining such information (from the video player logic application 347, via the video skin 315, and/or the browser 170) the control logic application 348 may then transmit all or a portion of the information to the backend service application 345. Upon receiving the information, the backend services application 345 may determine information about the end user. For example, the IP address may be used to determine the general location of the end user. In addition, based on information identifying the end user (e.g., retrieved by the browser via a cookie), the backend services application 345 may retrieve from memory user information (e.g., demographical information) previously supplied by the end user. Based on the received information and information determined by the backend services application 345, the backend services application 345 may then select, retrieve content elements (e.g., images, video, audio, etc.) from memory, and (in some instances) customize the retrieved content elements. In addition, or alternately, the BSA 345 may then transmit a request for digital information (e.g., content elements of images, video, audio, etc.), subsequently receive digital information from one or more third party web servers, and in some instances, customize the received digital information. The backend services application 345 then transmits the retrieved and/or received content elements to the control logic application 348.

Upon receipt of the data from the backend services application 345, the control logic application 348 may supply some information (such as some of the received content elements or other data) to the video player logic application 348 to, for example, be integrated into the video (to thereby customize the video) for viewing by the end user. In addition (or alternately) the control logic application 348 may present data (such as some of the received content elements or other data) to the user in the video skin ad 315 such as, for example, to provide a contextual advertisement in the video skin (e.g., a list of local cinemas that have a particular movie).

The control logic application 348 may also include subordination logic to ensure that the video skin ad 315 does not annoy or distract an end user who is watching and listening to a video. For example, the application 348 may include logic for limiting animation, ensuring colors do not flash, vibrate, and ensuring that the video content is not obscured with highly saturated images (e.g., bright reds, yellows, polka dots). In addition, the CLA 348 may control the video skin 315 by, for example, (1) pausing a video that is embedded in the video skin when the video content is playing unless it is activated by the user; (2) muting audio content that is embedded in the video skin 315 when the video content is playing unless it is activated by the user. The CLA 348 may request and receive information from the VPLA 347 in order to determine when to pause a video, mute the audio, darken colors, reduce animation, and perform other controls of the video skin ad 315. In addition, when the user interacts with a video skin ad 315 (e.g., by clicking on a link or entering data into a form), the CLA 348 may provide control messages to the VPLA 347 to pause the video. The video may remain paused until the user clicks the play button of the video player 320.

Also, because there are different types and sizes of video players 320, the CLA 348 may configure the ads (e.g., adjust to the size of the video player 320), or may be transmitted in a format and size that is appropriate for the video player 320. The video skin ads 315 may be displayed while the video player is displayed (e.g., for substantially the same time period), may be removed from the display before the video player 320 is removed, or may continue to be displayed after the video player 320 is removed for a predetermined time period or until a triggering event (e.g., a user actuation to close the video ad 315). Similar to the video skin ad 315, the interstitial ads 310 may be displayed in a separate CSS layer of the web page (e.g., in front of the video player), under control of a flash application, or via other suitable mechanisms.

The present invention has been described in the context of syndicating the delivery of contextual advertisements and customized video content to a plurality of clients via the internet. However, it is equally well suited for syndicating interactive content for providing contextual advertisements and/or customized video content via one or a plurality of mobile telephone networks (or a combination of the internet and mobile telephone networks) wherein the content is presented on wireless mobile telephones or other portable communication devices.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method of providing contextual content to an end user viewing a video in a video player on an end user computing device, the method comprising:
determining contextual data for the end user that comprises one or more of:
geographical information of the end user; and
demographical information of the end user;
determining advertising content to present to the end user based on the contextual data;
presenting the advertising content to the end user concurrently with the video player;
wherein the advertising content comprises a user input mechanism configured to receive information from the end user;
receiving information from the end user via the input mechanism;
determining secondary content to present to the user based on the received information; and
presenting the secondary content to the end user.

2. The method according to claim 1, further comprising
determining video metadata;
transmitting data based on the video metadata to a remote computer;
receiving one or more content elements in response to said transmitting; and
presenting the video with the one or more content elements integrated into the video.

3. The method according to claim 2, wherein the video metadata comprises one or more cue points for inserting one or more content elements.

4. The method according to claim 2, wherein the video metadata comprises information that provides an indication of the subject matter of the video.

5. The method according to claim 2, wherein the video metadata comprises information that provides an indication of a content type acceptable for insertion into the video.

6. The method according to claim 1, wherein the advertising content comprises content personalized for the end user.

7. The method according to claim 1, wherein said determining advertising content is based on geographical information of the end user, demographical information of the end user, and personal information of the end user.

8. The method according to claim 1, wherein said determining advertising content is based on geographical information of the end user, demographical information of the end user, and technical data related to the end user's computing device or network.

9. The method according to claim 1, further comprising subordinating the advertising content while the video is presented in the video player.

10. A method of providing contextual content to an end user viewing a video in a video player on an end user computing device, the method comprising:
determining advertising content to present to the end user based on three or more of:
geographical information of the end user;
demographical information of the end user;
personal information of the end user;
information of the video; and
technical information about the end user computing device or a network connected thereto; and
presenting the advertising content to the end user concurrently with the video player.

11. The method according to claim 10, further comprising:
customizing the video based on one or more of personal information of the end user and geographical information of the end user; and
presenting the customized video to the end user.

12. The method according to claim 10, wherein said determining advertising content is at least based on geographical information of the end user, demographical information of the end user, and personal information of the end user.

13. The method according to claim 10, further comprising subordinating the advertising content while the video is presented in the video player.

14. The method according to claim 10, wherein the advertising content comprises information of one or more venders local to the end user.

15. The method according to claim 10, wherein the advertising content comprises a user input mechanism configured to receive information from the end user, the method further comprising:
receiving information from the end user via the input mechanism;
determining secondary content to present to the user based on the received information; and
presenting the secondary content to the end user.

16. The method according to claim 10, wherein the advertising content is presented along a periphery of the video player.

17. The method according to claim 10, wherein the advertising content comprises content personalized for the end user.

18. A method of providing contextual content to an end user viewing a video in a video player, the method comprising:
determining advertising content to present to the end user;
presenting the advertising content to the end user concurrently with the video player and along a periphery of the video player;
wherein the advertising content comprises a user input mechanism configured to receive information from the end user;
receiving information from the end user via the input mechanism;
determining secondary content to present to the user based on the received information; and
presenting the secondary content to the end user.

19. The method according to claim 18, wherein said determining advertising content comprises determining advertising content based on geographical information and demographical information of the end user.

20. The method according to claim 18, wherein said determining advertising content comprises determining advertising content based contextual information about the end user.

21. The method according to claim 18, wherein the advertising content comprises information of one or more venders local to the end user.

22. The method according to claim 18, further comprising:
customizing the video based on one or more of personal information of the end user and geographical information of the end user; and
presenting the customized video to the end user in the video player.

23. The method according to claim 18, wherein said determining advertising content comprises determining advertising content based on geographical information of the end user.

24. A method of providing contextual content to an end user viewing a video in a video player in a client on an end user computing device, the method comprising:
receiving the video and video metadata via a network;
determining technical data that includes information of one or more of the type of the computing device, the type of client, and the type of network;
determining geographical data of the computing device;
transmitting at least a portion of the technical data and the geographical data to a remote computer;
receiving content in response to said transmitting; and
presenting content to the end user concurrently with display of the video player.

25. The method according to claim 24, wherein said presenting comprises presenting the content in a display area along a periphery of the video player.

26. The method according to claim 24, wherein said presenting comprises presenting the content as part of the video in the video player.

27. The method according to claim 24, wherein the content comprises a message personalized for the end user.

28. The method according to claim 24, wherein the content comprises information of one or more venders local to the end user.

29. The method according to claim 24, wherein said determining geographical data comprises:
determining an Internet Protocol (IP) address for the end user computing device; and
transmitting data of the IP address to a remote computer.

30. A method of providing contextual content to an end user viewing a video in a video player, the method comprising:
receiving the video;
receiving video metadata;
transmitting a request that includes data based on the video metadata information to a remote computer;
receiving one or more content elements in response to said transmitting; and
presenting the video with the one or more content elements integrated into the video.

31. The method according to claim 30, wherein at least one content element comprises a message personalized for the end user.

32. The method according to claim 30, wherein the video metadata comprises cue points.

33. The method according to claim 30, wherein the video metadata comprises parameter data of acceptable content elements.

34. The method according to claim 30, further comprising:
determining contextual data of the end user; and
transmitting the contextual data to the remote computer.

35. The method according to claim 34, wherein the one or more content elements are selected based on the contextual data.

36. The method according to claim 34, wherein the one or more content elements are generated based on the contextual data.

37. The method according to claim 30, wherein at least one content element comprises a custom message.
